(19) United States
(12) Patent Application Publication
(10) Pub. No.: US 2013/0114957 A1
(43) Pub. Date: May 9, 2013

(54) DUAL PATH WAVELENGTH SELECTIVE SWITCH

(71) Applicants: Jonathan D. HOMA, Livingston, NJ (US); Manish Sharma, Morgan Hill, CA (US)

(72) Inventors: Jonathan D. HOMA, Livingston, NJ (US); Manish Sharma, Morgan Hill, CA (US)

(21) Appl. No.: 13/288,887

(22) Filed: Nov. 3, 2011

(51) Int. Cl. H04J 14/02

(52) U.S. Cl. 398/48

(57) ABSTRACT

An optical switching device with a switch-and-select architecture uses a single multi-port optical channel router, such as a wavelength selective switch, as a bidirectional switching device. The optical switching device includes the multi-port optical channel router and optical circulators coupled to the input/output ports of the multi-port optical channel router. The optical circulators couple one or more output ports and one or more input ports of the optical switching device to the input/output ports of the optical channel router so that the optical channel router provides symmetric, bi-directional switching at an optical network node.

### BACKGROUND

1. Field of the Invention

Embodiments of the present invention relate generally to optical communication systems and components and, more particularly, to a wavelength selective switch.

2. Description of the Related Art

In a wavelength division multiplexing (WDM) optical communication system, information is carried by multiple channels, each channel having a unique wavelength. WDM allows transmission of data from different sources over the same fiber optic link simultaneously, since each data source is assigned a dedicated wavelength component, or channel. The result is an optical communication link with an aggregate bandwidth that increases with the number of wavelengths, or channels, incorporated into the WDM signal. In this way, WDM technology maximizes the use of an available fiber optic infrastructure; what would normally require multiple optic links or fibers instead requires only one.

At a network node of a WDM optical communication system, multiple fiber links are interconnected, and individual wavelength channels from each incoming fiber link are directed as desired to one or more output fibers. An optical switch configured to perform such optical switching on a per wavelength channel basis is referred to as a wavelength selective switch (WSS), and is typically capable of switching any wavelength channel at an input fiber to any desired output fiber. Thus, a 1×N WSS can switch any wavelength channel of the WDM input signal propagating along the input fiber to any of the N output fibers coupled to the WSS.

In the commonly used broadcast and select architecture, the wavelength channels from each incoming multi-wavelength fiber are typically demultiplexed along different spatial paths, and an optical splitter directs a copy of each wavelength channel to each output fiber. In such architecture, the optical power of a particular wavelength channel directed to any output fiber is inversely proportional to the number of output fibers coupled to the network node. With the introduction of high port-count WSSs, for example where N=20 or more, wavelength switching devices based on the broadcast and select architecture are not practical, since the insertion loss is so high, i.e., optical power is reduced by a factor of N for each wavelength channel.

To avoid high optical power loss when a large number of fibers are connected at a network node, a switch-and-select architecture can be used, in which a high port-count WSS is positioned at the ingress of a network node and another WSS is positioned at the egress of the network node. The use of two WSSs and no splitter results in low insertion loss since most optical power of a wavelength channel is directed to a desired output port. However, the use of multiple high port-count WSS devices at a network node increases the cost and complexity of the network node.

In light of the above, there is a need in the art for a simple optical switching device that provides wavelength channel switching for high port count applications that does not introduce high insertion loss.

### SUMMARY

One or more embodiments of the present invention set forth an optical switching device with a switch-and-select architecture that uses a single multi-port optical channel router. The optical switching device includes a multi-port optical channel router, such as a high port-count wavelength selective switch, and optical circulators coupled to the input/output ports of the multi-port optical channel router. The optical circulators couple one or more output ports and one or more input ports of the optical switching device to the input/output ports of the optical channel router so that the optical channel router provides symmetric, bi-directional switching at an optical network node.

According to one embodiment of the present invention, an optical switching device comprises first and second input ports, first and second output ports, a multi-port optical channel router, and an optical circulator. The multi-port optical channel router has a first input/output (I/O) port and a second I/O port. The optical circulator is coupled to the first input port, the first output port, and the first I/O port to direct an input optical signal from the first input port to the first I/O port and an output optical signal from the first I/O port to the first output port, The multi-port optical channel router is configurable to select any wavelength channel or channels from the input optical signal received through the first I/O port and direct the selected wavelength channel or channels to the second output port via the second I/O port and to select any wavelength channel or channels from an optical signal from the second input port and direct the selected wavelength channel or channels to the first I/O port.

According to another embodiment of the present invention, an optical switching device comprises first, second, and third input ports, first, second, and third output ports, a multi-port optical channel router, and first, second, and third optical couplers. The multi-port optical channel router has a first I/O port, a second I/O port, and a third I/O port, the first optical coupler is coupled to the first input port, the first output port, and the first I/O port to direct a first input optical signal from the first input port to the first I/O port and a first output optical signal from the first I/O port to the first output port. The second optical coupler is coupled to the second input port, the second output port, and the second I/O port to direct a second input optical signal from the second input port to the second I/O port and a second output optical signal from the second I/O port to the second output port. The third optical coupler is coupled to the third input port, the third output port, and the third I/O port to direct a third input optical signal from the third input port to the third I/O port and a third output optical signal from the third I/O port to the third output port. The multi-port optical channel router is configurable to select any wavelength channel or channels from the first input optical signal received through the first I/O port and direct the selected wavelength channel or channels to the second output port or the third output port via the second I/O port or the third I/O port, respectively, and to select any wavelength channel or channels from the second input optical signal received through the second I/O port or the third input optical signal received through the third I/O port and direct the selected wavelength channel or channels to the first I/O port.

According to yet another embodiment of the present invention, an optical switching device comprises first and second input ports, first and second output ports, a multi-port optical channel router, and a first directional coupler. The multi-port optical channel router has a first I/O and a second I/O port. The first directional coupler is coupled to the first input port, the first output port, and the first I/O port to direct an input optical signal from the first input port to the first I/O port and an output optical signal from the first I/O port to the first output port. The multi-port optical channel router is configurable to select any wavelength channel or channels from the input optical signal received through the first I/O port and direct the selected wavelength channel or channels to the second output port via the second I/O port and to select any wavelength channel or channels from an optical signal from the second input port and direct the selected wavelength channel or channels to the first I/O port.

### BRIEF DESCRIPTION OF THE DRAWINGS

So that the manner in which the above recited features of embodiments of the invention can be understood in detail, a more particular description of embodiments of the invention, briefly summarized above, may be had by reference to the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of an optical switching device, according to an embodiment of the invention.

FIG. 2 is a schematic illustration of an optical switching device, according to an embodiment of the invention.

FIG. 3 is a schematic illustration of an output face of an asymmetrical fiber concentrator array shown from a front view, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

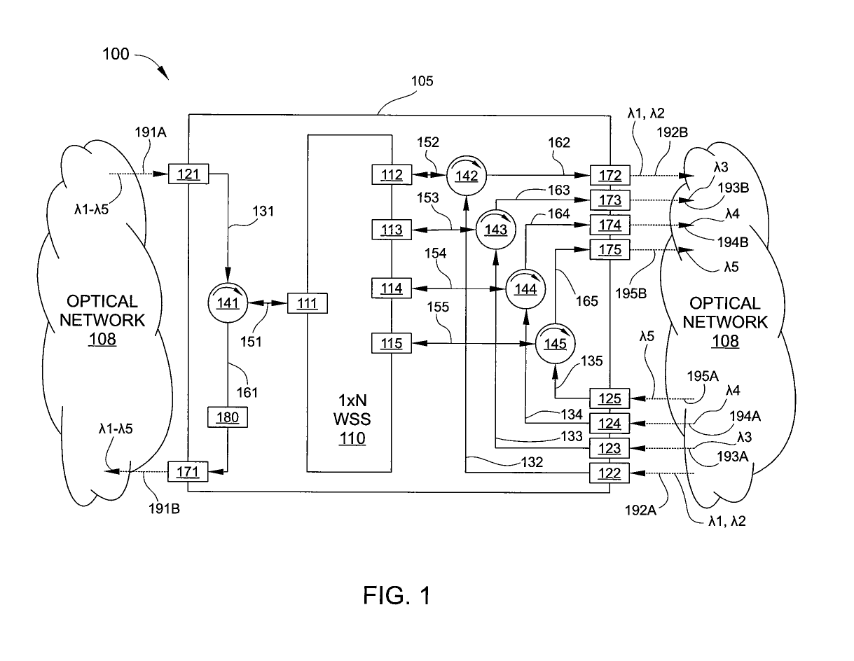

FIG. 1 is a schematic illustration of an optical switching device 100, according to an embodiment of the invention. Optical switching device 100 is configured to provide 1×N, symmetric, bi-directional switching of wavelength channels at an optical network node. For clarity, optical switching device 100 is illustrated in FIG. 1 as a 1×4 switching device. In other embodiments, the port count of optical switching device 100 is much larger, for example N=20 or more. Optical switching device 100 includes a multi-port optical channel router 110, ingress ports 121-125, egress ports 171-175, and optical couplers 141-145 arranged in a package 105 as shown. In some embodiments, optical switching device 100 further includes a wavelength blocker 180.

Multi-port optical channel router 110 is an integrated optical switching device, such as a wavelength selective switch (WSS), configured for switching signals on a per-wavelength basis between one or more WDM input signals and one or more WDM output signals. In the embodiment illustrated in FIG. 1, multi-port optical channel router 110 is a 1×N WSS (where N=4) configured to selectively direct the wavelength channels of one WDM input signal 191A from a common port to any of N WDM output signals 192B-195B at N opposing ports. Furthermore, according to embodiments of the invention, multi-port optical channel router 110 is used as a bidirectional device, and therefore is configured to simultaneously perform the opposite switching function, i.e., selectively directing any of the wavelength channels of N WDM input signals 192A-195A to a single WDM output signal 191B.

Multi-port optical channel router 110 may be any technically feasible WSS device known in the art. In some embodiments, multi-port optical channel router 110 performs wavelength multiplexing and demultiplexing of WDM signals using a diffraction grating, an arrayed waveguide grating (AWG), or other means. Wavelength-specific switching elements in multi-port optical channel router 110 may be based on microelectromechanical systems (MEMS) mirrors, liquid crystal-on-Silicon (LcoS) technology, liquid crystal beam-steering devices, or any other technically feasible wavelength selective switching mechanism. Typically, the number of wavelength channels multiplexed into each of WDM input signals 191A-195A and WDM output signals 191B-195B can be very large, e.g. 128 or more. Multi-port optical channel router 110 includes optical input/output (I/O) ports 111-115 that facilitate the bidirectional propagation of WDM signals into and out of multi-port optical channel router 110, in that optical signals both enter and exit multi-port optical channel router 110 via I/O ports 111-115. I/O port 111 is also referred to as the “common port” of multi-port channel router 110 and I/O ports 112-115 are also referred to as “opposing ports” of the common port.

Ingress (or “input”) ports 121-125 and egress (or “output”) ports 171-175 optically couple optical switching device 100 to a WDM optical network 108. As shown, WDM input signal 191A enters optical switching device 100 at ingress port 121 and a corresponding WDM output signal 191B exits optical switching device 100 at egress port 171. Similarly, WDM input signals 192A-195A enter optical switching device 100 at ingress ports 122-125, respectively, and corresponding WDM output signals 192B-195B exit optical switching device 100 at egress ports 172-175. To enable the use of multi-port optical channel router 110 as a bidirectional switching device, WDM input signal 191A and WDM output signal 191B include the same wavelength frequencies, e.g., λ1-λ5, and are routed to and from the same location or node in optical network 108. WDM input signal 192A is similarly paired with WDM output signal 192B, such that WDM input signal 192A and WDM output signal 192B each include the same wavelength frequency channels, e.g., λ1 and λ2, and are routed to and from a common location or node in optical network 108. In a similar manner, WDM input signal 193A and WDM output signal 193B share the same origin point and include the same wavelength frequency channel, e.g., λ3, WDM input signal 194A and WDM output signal 194B share the same origin point and include the same wavelength frequency channel, e.g., λ4, and WDM input signal 195A and WDM output signal 195B share the same origin point and include the same wavelength frequency channel, e.g., λ5.

Optical links 131-135, 151-155, and 161-165 optically couple elements of optical switching device 100, as shown. Specifically, optical links 131-135 direct WDM input signals 191A-195A from ingress ports 121-125 to optical couplers 141-145, respectively. Similarly, optical links 161-165 direct WDM output signals 191B-195B from optical couplers 141-145 to egress ports 171-175, respectively. Optical links 151-155 bidirectionally couple optical I/O ports 111-115 of multi-port optical channel router 110 to optical couplers 141-145, respectively. Optical links 131-135, 151-155, and 161-165 may be optical fibers, free-space optical paths conjoined with lenses and mirrors, or a combination of both.

Optical couplers 141-145 are non-reciprocal fiber-optic components that can be used to separate optical signals traveling in opposite directions in an optical fiber, analogous to the operation of a microwave or RF circulator. Optical couplers 141-145 are three-port devices designed such that light entering any port exits from the next. Thus, light entering optical coupler 141 from optical link 131 exits at optical link 151, whereas light entering optical coupler 141 from optical link 131 exits at optical link 161, rather than from optical link 131.

Each of optical couplers 141-145 is coupled to one of ingress ports 121-125, one of egress ports 171-175, and one of optical I/O ports 111-115, and is configured to direct an optical signal from the ingress port to the optical I/O port, and an optical signal from the I/O port to the input port. To wit, optical coupler 141 is optically coupled to ingress port 121 and egress port 171, directs WDM input signal 191A from ingress port 121 to I/O port 111, and directs WDM output signal 191B to from I/O port 111 to egress port 171. Similarly, optical couplers 142-145 are optically coupled to ingress ports 122-125, respectively, and egress ports 172-175, respectively. Thus, optical couplers 142-145 respectively direct WDM input signals 192A-195A from ingress ports 122-125 to I/O ports 112-115, and WDM output signals 192B-195B from I/O port 112-115 to egress ports 172-175.

In the embodiment illustrated in FIG. 1, optical couplers 141-145 are optical circulators, also referred to as fiber optic circulators. In other embodiments, each of optical couplers 141-145 may be a directional coupler, such as a four-port tap. It is noted that the application of optical couplers 141-145 in this fashion in optical switching device 100 enables the use of multi-port optical channel router 110 as a bi-directional switching element for optical switching device 100 that performs 1×N and N×1 switching simultaneously, i.e., multi-port optical channel router 110 is a dual path optical device. Consequently, only a single WSS or other channel routing device is needed for symmetrical, 1×N wavelength channel switching.

In some embodiments, optical switching device 100 further includes a wavelength blocker 180. Wavelength blocker 180 is a leveling device that has adjustable attenuation on a per-channel basis, and is configured to level the optical power associated with different wavelength channels routed onto the same fiber. Wavelength blocker 180 may comprise any technically feasible leveling device known in the art. In some embodiments, wavelength blocker 180 includes a diffraction grating to separate the wavelength channels of a WDM signal, such as WDM output signal 191B, and individual liquid crystal cells in a free-space configuration then control the attenuation of each wavelength channel using a polarization scheme. In other embodiments, a variable optical amplifier (VOA) is used to amplify wavelength channels having low power. In still other embodiments, MEMS, LCOS, or digital light processing (DLP™) technologies may be used attenuate light on a per-channel basis in wavelength blocker 180. In the embodiment illustrated in FIG. 1, wavelength blocker 180 is disposed between egress port 171 and optical coupler 141. In other embodiments, wavelength blocker 180 is disposed between ingress port 121 and optical coupler 141, or is located outside of optical switching device 100.

In operation, optical switching device 100 receives WDM input signal 191A at ingress port 121, and is routed to multi-port optical channel router 110 by optical coupler 141. Multi-port optical channel router 110 selectively switches the constituent wavelength frequencies of WDM input signal 191A, e.g., λ1-λ5, to the appropriate I/O port 112-115, so that each wavelength frequency is directed to the desired egress port 172-175. For example, in the configuration illustrated in FIG. 1, multi-port optical channel router 110 routes wavelength frequencies λ1 and λ2 to I/O port 112, so that wavelength frequencies λ1 and λ2 are directed to egress port 172 by optical coupler 142 as WDM output signal 192B. In a similar fashion, multi-port optical channel router 110 routes wavelength frequency λ3 to I/O port 113, so that wavelength frequency λ3 is directed to egress port 173 by optical coupler 143 as WDM output signal 193B; multi-port optical channel router 110 routes wavelength frequency λ4 to I/O port 114, so that wavelength frequency λ4 is directed to egress port 174 by optical coupler 144 as WDM output signal 194B; and multi-port optical channel router 110 routes wavelength frequency λ5 to I/O port 115, so that wavelength frequency λ5 is directed to egress port 175 by optical coupler 145 as WDM output signal 195B.

Due to the bidirectional nature of multi-port optical channel router 110, multi-port optical channel router 110 performs the opposite switching function simultaneously. Specifically, multi-port optical channel router 110 receives and demultiplexes WDM input signals 192A-195A at I/O ports 112-115, and selectively switches and multiplexes the desired constituent wavelength frequencies thereof to I/O port 111. In the example illustrated in FIG. 1, wavelength frequencies λ1, λ2 of WDM input signal 192A are directed to egress port 171 to make up part of WDM output signal 191B, while any other wavelength frequencies contained in WDM input signal 192A are directed to a light dump or otherwise terminated. Similarly, wavelength frequency λ3 of WDM input signal 193A, wavelength frequency λ4 of WDM input signal 1934, and wavelength frequency λ5 of WDM input signal 195A are directed to egress port 171.

It is noted that the above is a simplified operational example; WDM input signals 191A-195A and WDM input signals 191B-195B typically include much larger numbers of wavelength frequencies. It is further noted that multi-port optical channel router 110 is reconfigurable, and therefore can route wavelength frequencies λ1-λ5 to different egress ports as desired. For example, multi-port optical channel router 110 can be reconfigured during normal operation so that wavelength frequency λ1 is directed to egress port 173 rather than egress port 172, and is included in WDM output signal 193B rather than WDM output signal 192B. However, because multi-port optical channel router 110 is being used as a bidirectional device, in such a configuration, a corresponding wavelength frequency λ1 in the associated WDM input signal, i.e., WDM input signal 193A, will be directed to egress port 191B, rather than the wavelength frequency λ1 in WDM input signal 192A.

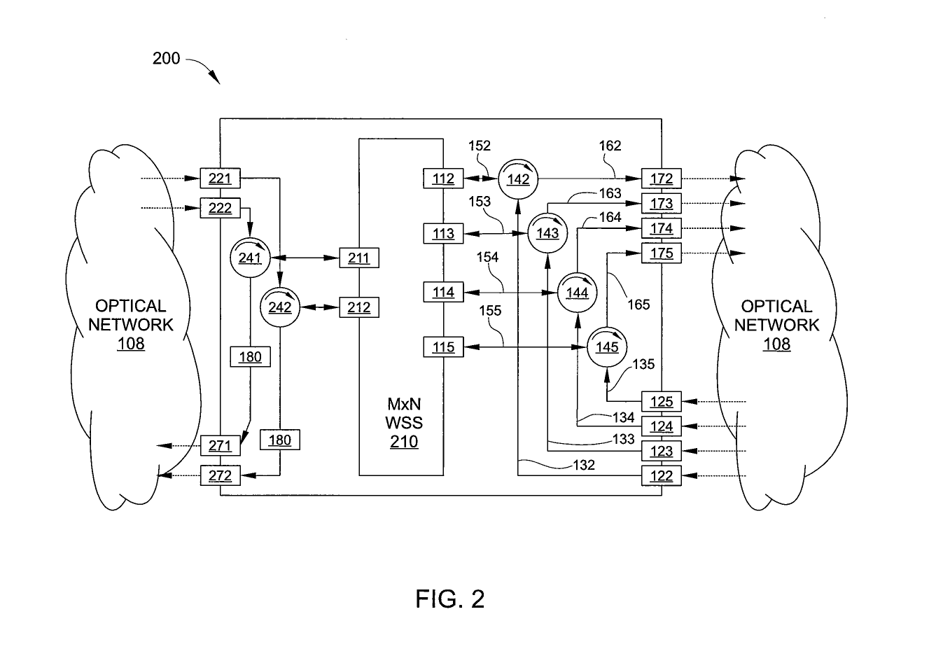

The embodiment of an optical switching device illustrated in FIG. 1 simultaneously provides 1×N and N×1 wavelength channel switching at an optical network node. Embodiments of the invention also contemplate M×N and N×M wavelength channel switching performed by a single dual path WSS device. FIG. 2 is a schematic illustration of an optical switching device 200, according to an embodiment of the invention. Optical switching device 200 is configured to provide M×N, symmetric, bi-directional switching of wavelength channels at an optical network node. For clarity, optical switching device 200 is illustrated in FIG. 2 as a 2x4 switching device, but in other embodiments, the port count of optical switching device 200 is much larger, for example where N, M=20 or more.

Optical switching device 200 is substantially similar in organization and operation to optical switching device 100 in FIG. 1, except that optical switching device 200 includes a multi-port optical channel router 210 that is configured as an M×N WSS and therefore can switch signals on a per-wavelength basis between a first set of M WDM signals and a second set of N WDM signals. To facilitate said switching capability, optical switching device 200 further includes an optical coupler, an ingress port, and an egress port for each of the M WDM signals whose wavelength channels are switched by multi-port optical channel router 210. In the embodiment illustrated in FIG. 2, M=2, consequently, optical switching device 200 includes two ingress ports 221, 222, two optical couplers 241, 242 and two egress ports 271, 272, and multi-port optical channel router 210 includes I/O ports 211, 212 coupled thereto as shown.

In embodiments in which multi-port optical channel router 110 and 210 include reflective fiber optic switching elements, such as MEMS mirror arrays, crosstalk, i.e., unwanted coupling, between ingress ports 121-125 and egress ports 171-175 can occur. Symmetrical spacing between fibers coupled to an optical channel router at a free-space interface often results in the introduction of unwanted crosstalk between the fibers. In some embodiments, multi-port optical channel router 110 and 210 include a collimator configured with an asymmetrical or non-uniform collimator spacing to reduce or eliminate cross-talk between ingress ports 121-125 and egress ports 171-175.

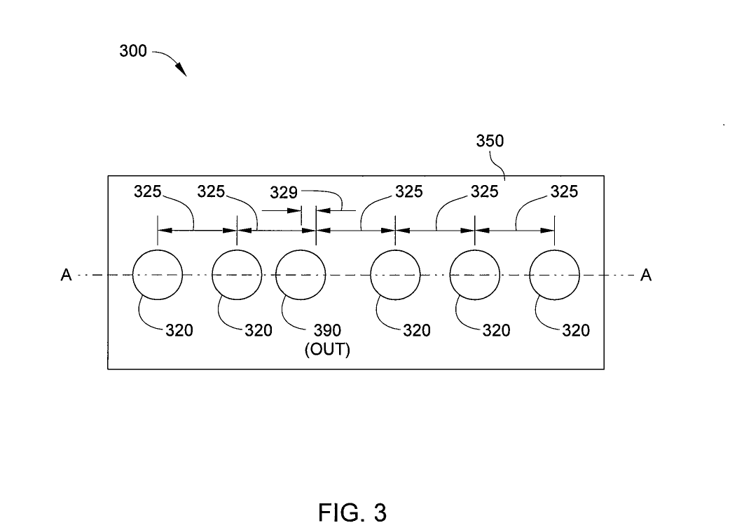

FIG. 3 is a schematic illustration of an output face 350 of an asymmetrical fiber concentrator array (FCA) 300 shown from a front view, according to embodiments of the invention. Preferably, FCA 300 comprises a termination point along output face 310 defining an interface with free-space between multiple input fibers, such as optical links 152-155, and multi-port optical channel router 110. FCA 300 includes input fiber port apertures 320 and an output fiber port 390. As shown, input fiber port apertures 320 are aligned along a linear axis A-A and have an equal core-to-core spacing 325. In contrast, an offset 329 in the position of output fiber port 390 relative to the adjacent input fiber port apertures 320 produces an asymmetrical spacing of the output fiber port 390. Input optical signals propagating within optical fibers and/or waveguides within FCA 300 exit the fiber and/or waveguide at output face 350, and propagate through free-space, reflecting from a reflective switching element, and entering output fiber port 390. Offset 329 has been shown to create a significant isolation effect between input fiber port apertures 320 and output fiber port 390, even when the magnitude of offset 329 is on the order of a few micrometers. A detailed description of selecting offset 329 for a particular configuration of FCA 300 is described in greater detail in U.S. Pat. No. 7,826,697.

In sum, embodiments of the invention set forth an optical switching device with a switch-and-select architecture that uses a single multi-port optical channel router as a dual path optical device. One advantage of the present invention is that an optical switching device combines the low insertion loss of a switch-and-select architecture with the reduced complexity and cost of a single optical channel router.

While the foregoing is directed to embodiments of the present invention, other and further embodiments of the invention may be devised without departing from the basic scope thereof, and the scope thereof is determined by the claims that follow.

We claim:

1. An optical switching device comprising:
first and second input ports;
first and second output ports;
a multi-port optical channel router having a first input/output (I/O) port and a second I/O port; and
an optical circulator coupled to the first input port, the first output port, and the first I/O port to direct an input optical signal from the first input port to the first I/O port and an output optical signal from the first I/O port to the first output port,
wherein the multi-port optical channel router is configurable to select any wavelength channel or channels from the input optical signal received through the first I/O port and direct the selected wavelength channel or channels to the second output port via the second I/O port and to select any wavelength channel or channels from an optical signal from the second input port and direct the selected wavelength channel or channels to the first I/O port.

2. The optical switching device of claim 1, further comprising a second optical circulator coupled to the second input port, the second I/O port, and the second output port, wherein the wavelength channel or channels selected from the optical signal received through the first I/O port are directed to the second output port through the second optical circulator.

3. The optical switching device of claim 2, further comprising a third input port, a third output port, and a third optical circulator, wherein the third optical circulator is coupled to the third input port, the third output port, and a third I/O port of the multi-port optical channel router.

4. The optical switching device of claim 3, wherein the first I/O port comprises a common port and the second I/O port and the third I/O output port comprise opposing ports of the common port.

5. The optical switching device of claim 1, wherein the selected wavelength channel or channels directed to the second output port are the same wavelength or wavelengths as the selected wavelength channel or channels directed to the first output port.

6. The optical switching device of claim 1, wherein the input optical signal from the first input port comprises a wavelength division multiplexed optical signal.

7. The optical switching device of claim 1, further comprising an optical leveling device configured to adjust attenuation of individual wavelength channels.

8. The optical switching device of claim 7, wherein the optical leveling device is optically coupled to the first output port.

9. The optical switching device of claim 1, wherein the multi-port optical channel router includes an asymmetrical fiber concentrator array.

10. An optical switching device comprising:
first, second, and third input ports;
first, second, and third output ports;
a multi-port optical channel router having a first I/O port, a second I/O port, and a third I/O port;
a first optical coupler coupled to the first input port, the first output port, and the first I/O port to direct a first input optical signal from the first input port to the first I/O port and a first output optical signal from the first I/O port to the first output port;
a second optical coupler coupled to the second input port, the second output port, and the second I/O port to direct a second input optical signal from the second input port to the second I/O port and a second output optical signal from the second I/O port to the second output port; and
a third optical coupler coupled to the third input port, the third output port, and the third I/O port to direct a third input optical signal from the third input port to the third I/O port and a third output optical signal from the third I/O port to the third output port,
wherein the multi-port optical channel router is configurable to select any wavelength channel or channels from the first input optical signal received through the first I/O port and direct the selected wavelength channel or channels to the second output port or the third output port via the second I/O port or the third I/O port, respectively, and to select any wavelength channel or channels from the second input optical signal received through the second I/O port or the third input optical signal received through the third I/O port and direct the selected wavelength channel or channels to the first I/O port.

11. The optical switching device of claim 10, wherein the selected wavelength channel or channels directed to the second output port or the third output port are the same wavelength or wavelengths as the selected wavelength channel or channels directed to the first I/O port.

12. The optical switching device of claim 10, further comprising a fourth input port, a fourth output port, and a fourth optical coupler, wherein the fourth optical coupler is coupled to the fourth input port, the fourth output port, and a fourth I/O port of the multi-port optical channel router to direct a fourth input optical signal from the fourth input port to the fourth I/O port and a fourth output optical signal from the fourth I/O port to the fourth output port, wherein the multi-port optical channel router is configurable to select any wavelength channel or channels from the first input optical signal received through the first I/O port or the fourth input optical signal received through fourth I/O port and direct the selected wavelength channel or channels to the second output port or the third output port.

13. The optical switching device of claim 12, wherein each of the first, second, third, and fourth input optical signals comprises a wavelength division multiplexed optical signal.

14. The optical switching device of claim 10, further comprising an optical leveling device configured to adjust attenuation of individual wavelength channels.

15. The optical switching device of claim 10, wherein the multi-port optical channel router includes an asymmetrical fiber concentrator array.

16. The optical switching device of claim 10, wherein the first, second, and third optical couplers each comprise one of a directional coupler and an optical circulator.

17. An optical switching device comprising:
first and second input ports;
first and second output ports;
a multi-port optical channel router having a first I/O and a second I/O port; and
a first directional coupler coupled to the first input port, the first output port, and the first I/O port to direct an input optical signal from the first input port to the first I/O port and an output optical signal from the first I/O port to the first output port,
wherein the multi-port optical channel router is configurable to select any wavelength channel or channels from the input optical signal received through the first I/O port and direct the selected wavelength channel or channels to the second output port via the second I/O port and to select any wavelength channel or channels from an optical signal from the second input port and direct the selected wavelength channel or channels to the first I/O port.

18. The optical switching device of claim 17, further comprising a second directional coupler coupled to the second input port, the second I/O port, and the second output port, wherein the wavelength channel or channels selected from the optical signal received through the first I/O port are directed to the second output port through the second directional coupler.

19. The optical switching device of claim 17, further comprising an optical leveling device configured to adjust attenuation of individual wavelength channels.

20. The optical switching device of claim 17, wherein the multi-port optical channel router includes an asymmetrical fiber concentrator array.
